(19) United States
(12) Patent Application Publication
(10) Pub. No.: US 2003/0115184 A1
(43) Pub. Date: Jun. 19, 2003

(54) Method and apparatus for simplifying and accelerating the definition, dynamic generation and identification of geographic regions

(76) Inventor: Peter Steffen Ebert, Menlo Park (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/019,672

(22) PCT Filed: May 3, 2001
(86) PCT No.: PCT/US01/40659

(51) Int. Cl. G06F 7/00

(52) U.S. Cl. 707/3; 701/208

(57) ABSTRACT

A system and method for defining, generating and identifying a geographic area is disclosed. This may be done by establishing zip codes as the basic building blocks for the geographic area. For example, the United States may represent a region, which includes all of the zip codes in the United States. A region may also be divided into mutually exclusive subregions. For example, individual states within the United States may represent the subregions, wherein the individual states represent all of the zip codes within that state. The subregions are then divided into mutually exclusive sections. For example, zip codes within the individual states may represent the sections. Simplified syntax is then used to allow a user to submit a query including parameters to identify subregions or sections that are to be included or excluded from the defined geographic area within the region. The system then processes this query and outputs a response representative of the query.

### RELATED APPLICATION DATA

This application is related to and claims priority to U.S. Provisional Application No. 60/202,083, filed May 4, 2000, entitled “Method for Simplifying and Accelerating the Definition, Dynamic Generation and Identification of Geographic Regions,” which is expressly incorporated herein by reference in its entirety.

### BACKGROUND OF THE INVENTION

1. Field of the Invention

This invention relates generally to identifying geographic areas, and more specifically, to methods and systems for defining, generating, and identifying geographic areas.

2. Description of Related Art

The defining, generating and identifying geographic areas is important in a variety of business applications. For example, the sales department of a business that manufactures a particular product would divide the potential market into geographic areas, which are then assigned to individual sales representatives in the sales force. A sales representative would concentrate solicitation activities within his or her assigned area. It is important that the sales representative's assigned area be mutually exclusive from the other sales representative's assigned areas so that no two sales representatives are working the same geographic area. The process of dividing the potential market into these geographic areas may be cumbersome using the tools that are available today.

There are software programs on the market that are able to divide up a region into geographic areas. For example, telephone area codes are commonly used to divide up geographic regions. This may present a problem as telephone area codes are often changed, thus upsetting a previously defined geographic area. Further, since these programs may not divide up a geographic region into mutually exclusive areas, the end result may be overlapping areas.

Further, the tools typically used require the incorporation of fieldnames, operators, values and Boolean functions to include or exclude a particular area. Thus, the expression of the definition of a geographic area could be potentially lengthy and complicated and require skilled programmers to create.

Additionally, there are geographical information systems that define a geographic area by using the so-called polygon method, where a polygon is formed around the defined geographic area. This process is usually performed by using polygon drawing tools layered on top of a map, or by merging selected geographical features into a new polygon. Both of these approaches are cumbersome and time-consuming.

Thus, there remains a need to provide a useful tool in defining a geographic area within a region that uses simple syntax, is faster to use and integrates with standard database and geospatial database applications.

### SUMMARY OF THE INVENTION

In accordance with the invention, as embodied and broadly described herein, methods and systems consistent with the principles of the invention provide for systems and methods for defining and identifying geographic areas. The methods and systems include providing for a geographic region wherein the geographic region is divided into subregions that are mutually exclusive, and wherein the subregions are divided into sections that are mutually exclusive; receiving a query for defining a geographic area wherein the query includes an indication of at least one of a set of subregions and a set of sections; determining whether the reference to at least one of the set of subregions and the set of sections indicates the at least one of the set of subregions and the set of sections are to be included in the geographic area; determining whether the reference to the at least one of the set of subregions and the set of sections indicates the at least one of the set of subregions and the set of sections are to be excluded from the geographic area; and outputting a response which may include a pictorial diagram of the geographic area wherein the geographic area represents the query.

In accordance with another aspect of the invention, as embodied and broadly described herein, methods and systems for defining and identifying geographic areas are provided for. These methods and systems include providing for a geographic region wherein the geographic region is divided into states, and wherein the states are divided into postal codes; receiving a query to identify a geographic area wherein the query includes a, indication of at least one of a set of states and a set of postal codes and including in the query at least one of a plus sign and a minus sign, wherein the plus sign is included when at least one of the set of states and one of the set of postal codes is to be included in the geographic area and a minus sign is included when at least one of the set of states or one of the set of postal codes is to be excluded from the geographic region; and outputting a response including information related to the geographic area wherein the at least one of the set of states and the set of postal codes preceded with a plus sign is included in the geographic area and the at least one of the set of states and the set of postal codes preceded with a minus sign is excluded from the geographic area.

In accordance with yet another aspect of the invention, as embodied and broadly described herein, methods and systems for defining a geographic area. These methods and systems include providing for a geographic region wherein the geographic region is divided into subregions that are mutually exclusive, and wherein the subregions are divided sections that are mutually exclusive; receiving a query to define a geographic area wherein the query includes an indication of at least one of a set of subregions and a set of sections and including in the query at least one of a plus sign and a minus sign, wherein the plus sign is included when at least one of the set of subregions and one of the set of sections is to be included in the geographic area and a minus sign is included when at least one of the set of subregions or one of the set of sections is to be excluded from the geographic region; and outputting a pictorial diagram representative of the query wherein the pictorial diagram includes at least part of the region including the defined geographic area wherein the geographic area is viewably different from the subregions and sections that are excluded from the geographic area.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

The accompanying drawings, which are incorporated in and constitute a part of this specification, illustrate the embodiments of the invention and, together with the description, explain the principles of the invention. In the drawings,

FIG. 1 is an exemplary computer-based system environment for implementing the features of the principles of the present invention;

FIG. 2 is an exemplary diagram of the components of a computer system consistent with the principles of the present invention;

FIG. 3 is an exemplary flow diagram of the steps performed by a user to define a geographic area consistent with the principles of the present invention;

FIG. 4 is an exemplary flow diagram of the steps performed by a computer system to identify and generate a geographic area consistent with the principles of the present invention;

FIG. 5 is an exemplary flow diagram of the steps performed by a computer system in interpreting a query and generating a geographic area consistent with the principles of the present invention; and

FIG. 6 is an diagram displaying an exemplary query to be processed consistent with the principles of the present invention; and

FIG. 7 is an exemplary image created by a computer system consistent with the principles of the present invention.

### DETAILED DESCRIPTION

Reference will now be made in detail to the principles of the invention, examples of which are illustrated in the accompanying drawings. Wherever possible, the same reference numbers will be used throughout the drawings to refer to the same or like parts.

### Overview

The present invention relates generally to a system and method for defining, generating and identifying a geographic area. This may be done by establishing zip codes, or postal codes, as the basic building blocks for the geographic area. For example, the United States may represent a region, which includes all of the zip codes, or postal codes, in the United States. A region may be divided into mutually exclusive subregions. For example, individual states within the United States may represent the subregions, wherein the individual states represent all of the zip codes within that state. The subregions are then divided into mutually exclusive sections. For example, zip codes within the individual states may represent the sections. Simplified syntax is then used to allow a user to submit a query including parameters to identify subregions or sections that are to be included or excluded from the defined geographic area within the region. The system then processes this query and outputs an image including the geographic area representative of the query.

### System Architecture

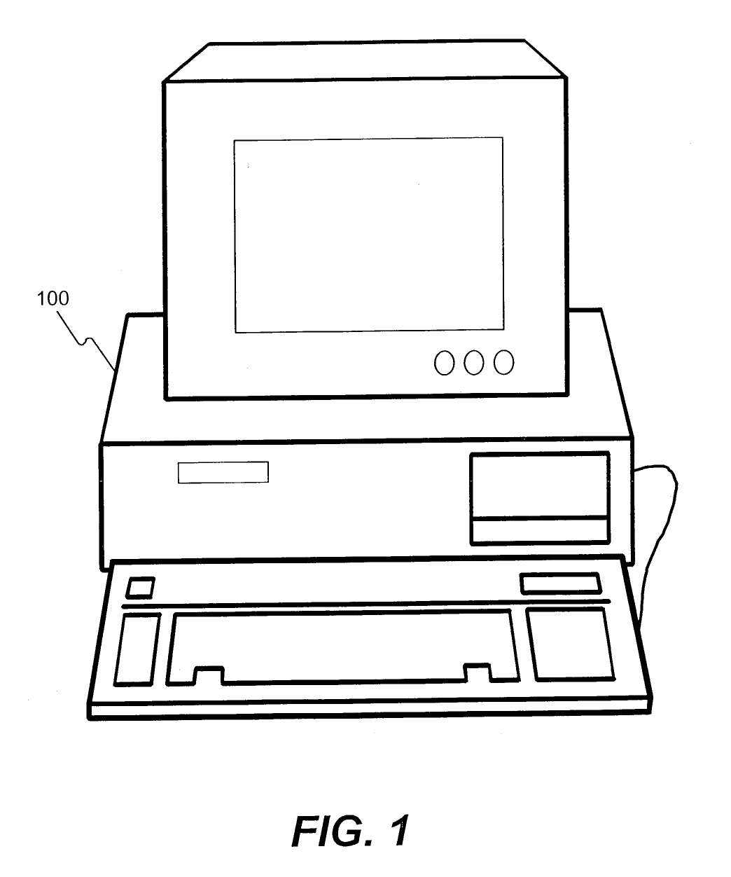

FIG. 1 depicts an exemplary diagram of a computer-based system environment 100 for implementing the principles of the present invention. The components of system 100 may be implemented through any suitable combinations of hardware, operating system and application software, and/or firmware. One of ordinary skill in the art can appreciate that the system may be implemented in a network configuration including a client computer and a server computer wherein the software may reside on a server computer. The network may be implemented as a local area network or a wide area network. Client computer may then access software through the network.

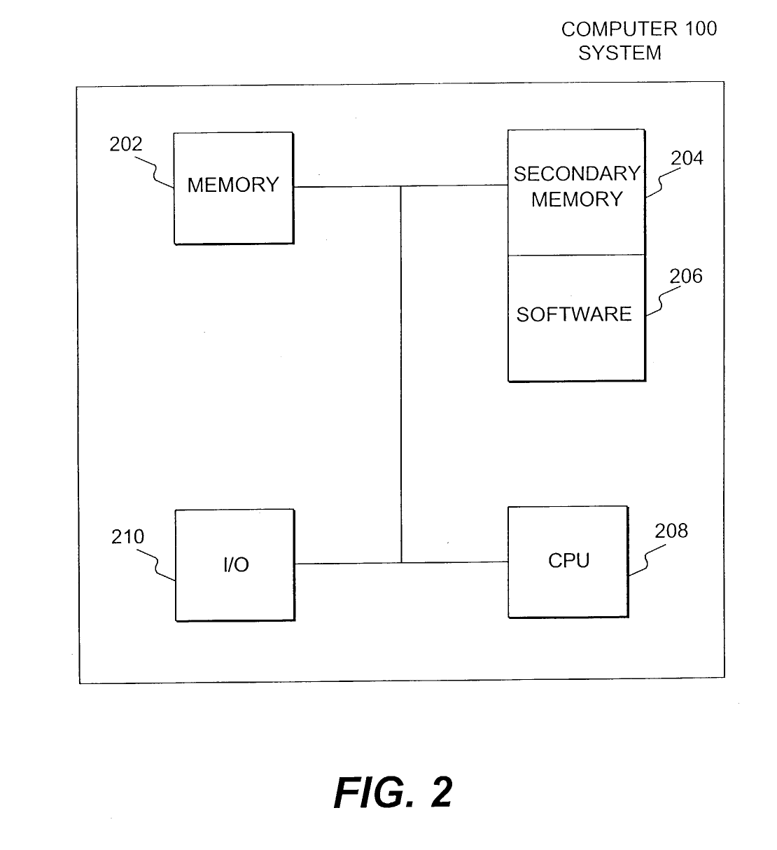

FIG. 2 depicts an exemplary block diagram of components contained in computer system 100. Computer system 100 may be of any type of computing device and may include, as shown in FIG. 2, memory 202, secondary memory 204, software 206, central processing unit 208, and input/output (I/O) devices 210. The components of system 100 may be implemented through any suitable combinations of hardware, software, and/or firmware. Software 206 contains program instructions for implementing principles consistent with the present invention., such as assisting users in defining, generating and identifying geographic areas. Software 206 may also include a conventional mapping software application.

### Defining, Generating and Identifying Geographic Regions

As set forth above, a region may be represented, for example, as the United States. The region may be divided up into building blocks, which may be used to define a geographic area. The region may be divided into subregions and may be represented for example, as individual states. These states are used in a query by using the two-character code used by the Postal Service. For example, “NY” represents the state of New York. Subregions may be divided up into the smallest building blocks, called sections, and may be represented, for example, as zip codes within the individual states. Zip codes may be used in a query by indicating the five-digit number representing a particular zip code. It is possible to identify a section that is larger than one zip code. For example, “943” may represent all zip codes that begin with the numbers 943. This larger section may be used in a query by indicating the 1, 2, 3, or 4 digits representing one or more zip code areas that begins with those 1, 2, 3, or 4 numbers.

It is beneficial to use zip codes as the smallest building block because zip codes are not overlapping, the land that a zip code covers is small, so that a user may be more precise in defining the geographic area, and every part of the region falls within a zip code. Further, zip codes do not change frequently, thus constant updating of a geographic area is unnecessary.

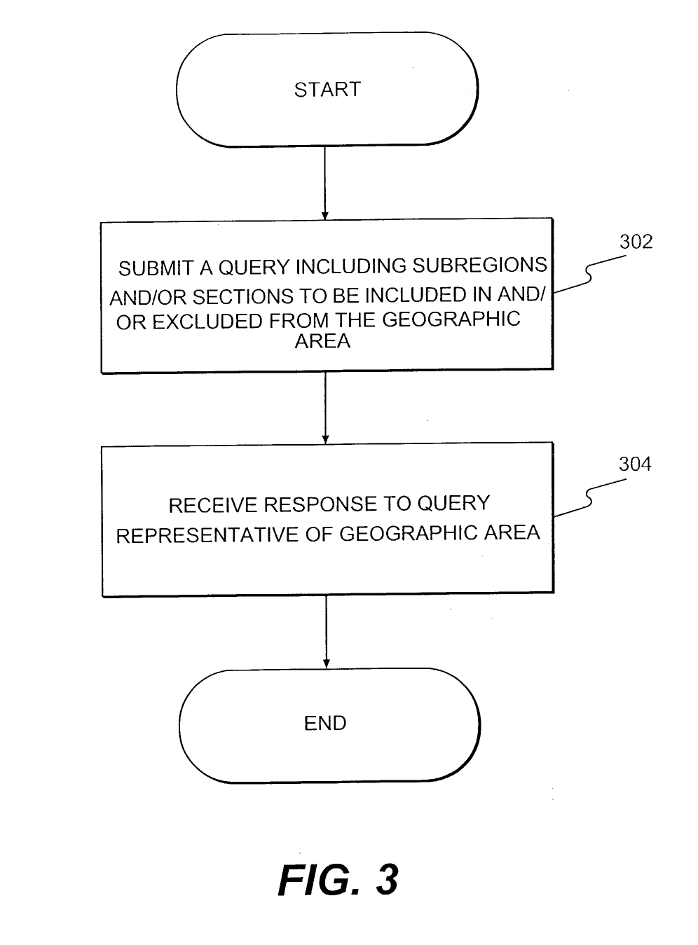

FIG. 3 depicts a flow diagram of the steps performed by a user to define a geographic area consistent with the principles of the present invention. As shown in FIG. 3, a user submits a query using software 206 to computer system 100 setting forth the parameters identifying the subregions and/or sections to include and/or exclude in the geographic area (Step 302). Computer system 100 then processes the query and submits a response to the user which may incorporate a diagram, or image, reflecting the geographic area including those subregions and sections that the user requested to be included, and excluding those subregions and sections which the user requested to be excluded (Step 304). It can be appreciated by one of ordinary skill in the art that the response may incorporate text-based information related to the geographic area representative of the query.

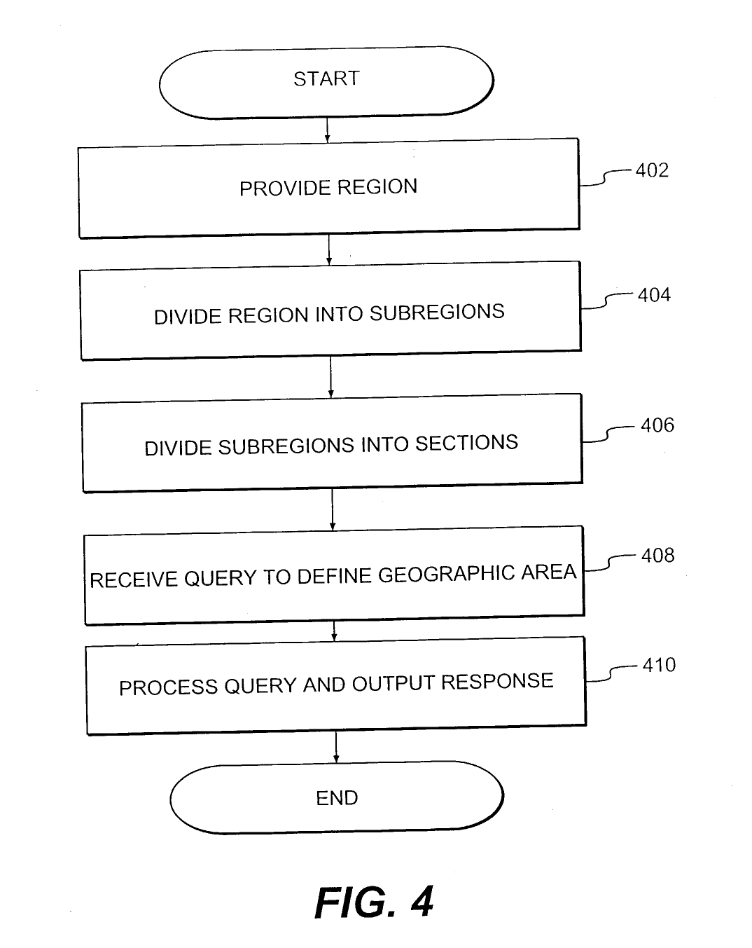

FIG. 4 depicts a flow diagram of the steps performed by computer system 100 to provide for a region wherein a geographic area may be defined, generated and identified. Software 206, located in computer system 100 provides for a region (step 402) that is capable of being divided into mutually exclusive subregions (Step 404). Computer system 100 further provides for the subregions that are capable of being divided into mutually exclusive sections (Step 406). It can be appreciated to one of ordinary skill in the art that the format of this region set forth above may be accessed through a conventional mapping software application.

Computer 110 then receives a query to define, generate, and identify a geographic area (Step 408). The query includes parameters denoting the user's selection of those subregions and sections to be included in or excluded from the geographic area. After processing the query, computer system 100 outputs a response which may include a visual representation of a geographic area that is representative of the query (Step 410). The response includes those subregions and sections the user indicated in the query to be included in the region. The response excludes those subregions and sections the user indicated in the query to be excluded from the geographic area. Further, the response distinguishes those subregions and sections to be included in the geographic area from those subregions and sections that are to be excluded from the geographic area. This may be accomplished by using one color to denote those subregions and sections that are to be included in the geographic area and a different color to denote those subregions and sections that are to be excluded from the geographic area. It can be appreciated by one skilled in the art that there are a variety of ways of distinguishing the included subregions and sections from the excluded subregions and sections, including using different shading, or textures, or omitting the excluded regions from the visual representation or response.

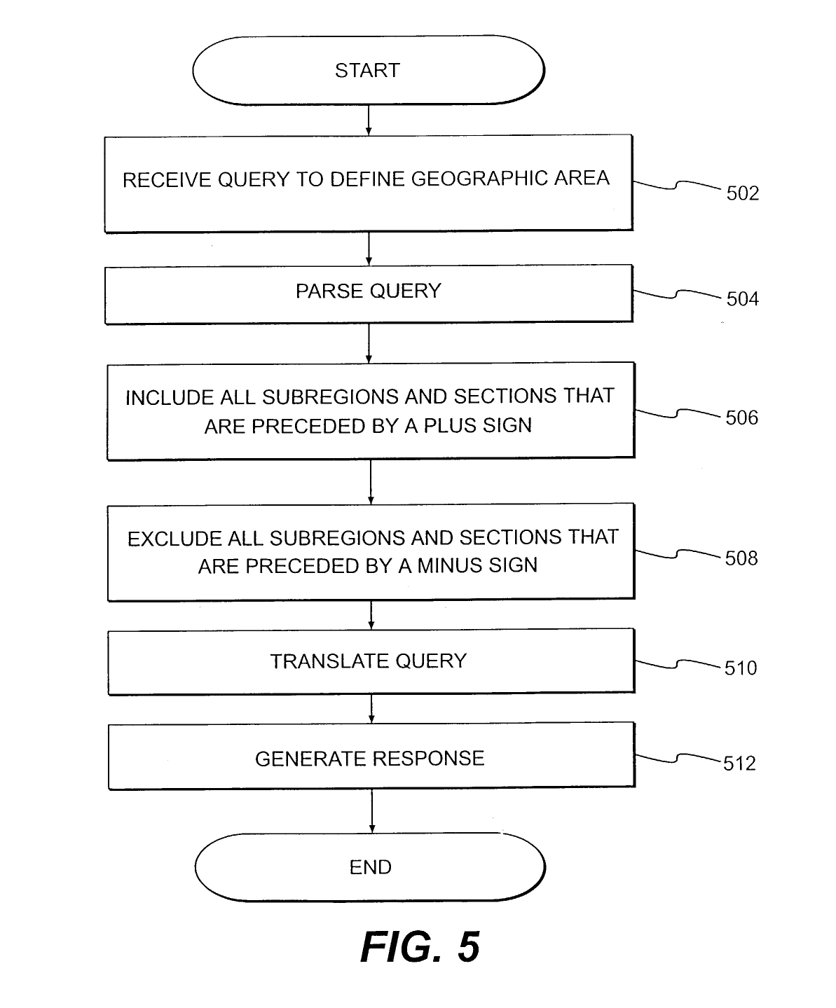

FIG. 5 depicts a flow diagram of the steps performed by computer system 100 in processing a query submitted by the user. As shown in FIG. 5, a query is received by computer system 100 to define a geographic area (step 502). Computer system 100 parses the query to find and interpret the operators in the query (Step 504). For example, if the query includes a plus sign in front of a subregion or section, then that subregion or section is included in the geographic region (Step 506). If a subregion or section at the beginning of the query is not preceded by any operator, a plus sign is presumed to precede the subregion or section. If the query includes a minus sign in front of a subregion or a section, then that subregion or section is excluded from the geographic region (Step 508). If the query includes a reference to a zip code, using 1, 2, 3, or 4 digits, to represent those zip codes starting those 1, 2, 3, or 4 digits, the system will translate that query to a range function. The system further processes the query to recognize the two-character state name and the zip code digits as such.

After the system determines which subregions and sections are to be included in the geographic area, and which subregions and sections are to be excluded from the geographic area, the system translates the query into language the mapping application may process and submits the translated query to the mapping application (Step 510). One of ordinary skill in the art can appreciate how to perform the translation process. For example, a mapping application may have the capability of interpreting SQL commands. As such, a query, consistent with the present invention, such as “UT+NV-94304” would be translated to a SQL command “Area=(([state]=‘Utah’) OR ([state]]=‘Nevada’) AND NOT ([postalcode]=‘94304’))” The mapping application then generates a response, which may be in the form of an image, including in the response those subregions and/or sections preceded by a plus sign, or no sign, and excludes from the image those subregions and/or section preceded by a minus sign, or not included in the query (Step 512). It can be appreciated by one of ordinary skill in the art that the output may be in the form of text-based information describing the geographic area representative of the query. For example, in the example above, the instead of the system generating an image, the system may generate text such as “Utah, Nev. and Postal Code 94304”. The output may also contain a combination of an image and text-based information.

It can further be appreciated by one of ordinary skill in the art, that, through the mapping application, the user may be able to zoom in to enlarge the defined geographic area, thus potentially providing more detail. This detail may include states, cities, towns, counties, zip codes, street names, etc. In contrast, the user may be able to zoom out thus making the geographic area smaller, allowing the user to view surrounding sections and subregions that may not be included in the geographic area as defined in the query.

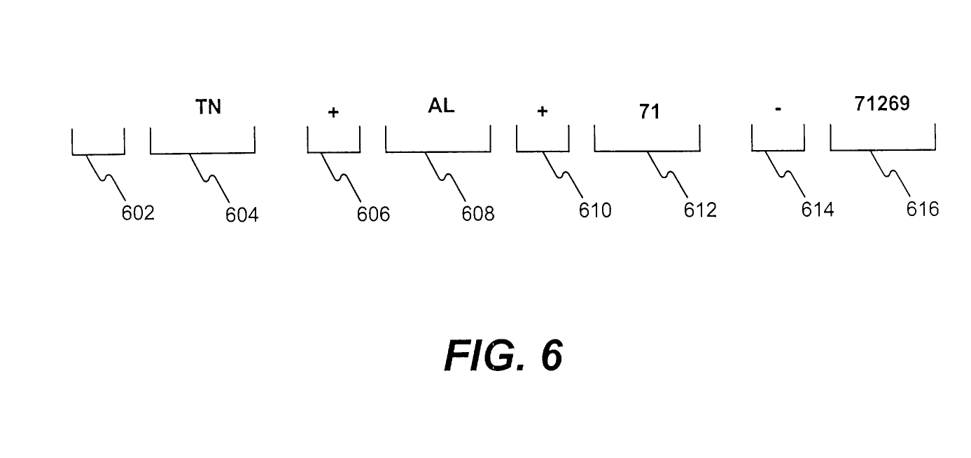

FIG. 6 depicts an exemplary query submitted by a user to be processed by computer system 100 for defining, identifying and generating a geographic area consistent with the principles of the present invention. As set forth above, computer system 100 parses the query to locate the operators and the subregions and sections that are incorporated in the query. As shown in FIG. 6, the exemplary query consists of a first segment 604 containing the two-character state code “TN” representing the state of Tennessee. Since there is no operator in front of segment 604, as set forth above, a plus sign is assumed for segment 602. Thus, after parsing segments 602 and 604 in this example, the entire state of Tennessee is to be included in the geographic area. Segment 606 contains a plus sign, followed by segment 608, which contains the two-character-state code “AL”, which indicates that the state of Alabama is to be included in the geographic area. Segment 610 contains a plus sign followed by segment 612 containing the digits “71”, which indicates that all zip codes beginning with the digits 71 are to be included in the area. Segment 614 contains a minus sign, followed by segment 616 containing the digits “71269”, which indicates that zip code 71269 is to be excluded from the geographic area.

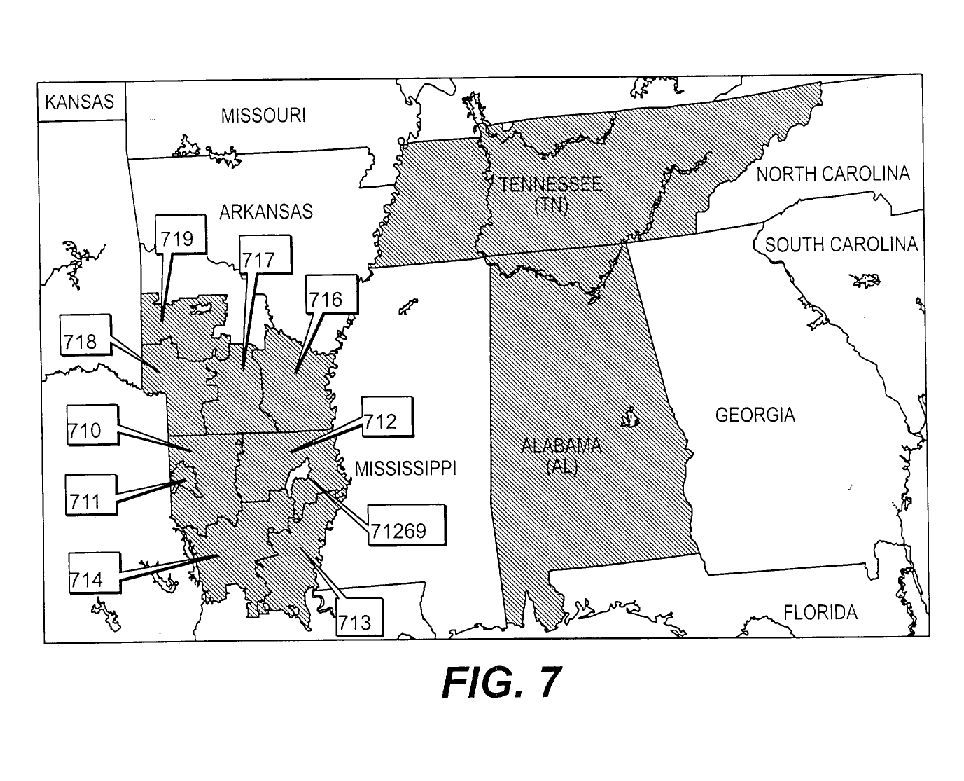

FIG. 7 depicts an exemplary image displaying the geographic area corresponding to the exemplary query depicted in FIG. 6. As can be seen from FIG. 7, there are two different types of shading. The darker shading indicates those subregions and sections that are included in the queried geographic area. The light shading indicates those subregions and sections that are excluded from the queried geographic area. The entire state of Tennessee is depicted in FIG. 7 by using the darker shading, thus, indicating Tennessee is included in the geographic area (FIG. 6, 602, 604). The entire state of Alabama is depicted in FIG. 7 by using the darker shading, thus, indicating that Alabama is also included in the queried geographic area (FIG. 6, 606, 608). Zip codes beginning with the digits 71, which were also queried in the example, and are depicted in FIG. 7 by using the darker shading, thus, these zip codes are included in the geographic area (FIG. 6, 610, 612). Zip code 71269 is depicted in FIG. 7 by using the lighter shading, as a result of this zip code being excluded in the queried geographic area (FIG. 6, 614, 616).

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or in hardware alone. Additionally, although aspects of the present invention are described for being stored in memory, one skilled in the art will appreciate that these aspects may also be stored on other types of computer-readable media, such as secondary storage devices, for example, hard disks, floppy disks, or CD-ROM; the Internet or other propagation medium; or other forms of RAM or ROM. It is intended that the specification and examples be considered as exemplary only, with a true scope and spirit of the invention being indicated by the following claims.

What is claimed is:

1. A method for defining and identifying geographic areas, comprising:
providing for a geographic region wherein the geographic region is divided into subregions that are mutually exclusive, and wherein the subregions are divided into sections that are mutually exclusive;
receiving a query for defining a geographic area wherein the query includes an indication of at least one of a set of subregions and a set of sections;
determining whether the reference to at least one of the set of subregions and the set of sections indicates the at least one of the set of subregions and the set of sections are to be included in the geographic area;
determining whether the reference to the at least one of the set of subregions and the set of sections indicates the at least one of the set of subregions and the set of sections are to be excluded from the geographic area; and
outputting a response including information relating to the geographic area wherein the geographic area is representative of the query.

2. The method of claim 1, wherein the subregions are states and the sections are postal codes.

3. The method of claim 2, wherein sections can be identified by at least one number included in the postal code, starting with the first number of the postal code.

4. The method of claim 1, wherein receiving a query includes:
incorporating in the query a plus sign to add at least one of a subregion contained in the set of subregions and a section contained in the set of sections to the geographic area; and
incorporating in the query a minus sign to exclude at least one of a subregion contained in the set of subregions and a section contained in the set of sections to the geographic area.

5. The method of claim 1, wherein outputting the response further includes:
incorporating in the response a pictorial diagram of the geographc area; and
depicting the subregions and sections that are included in the geographic region in a different manner than the subregions and sections that are excluded from geographic area.

6. The method of claim 5, wherein depicting the subregions and sections further includes denoting the subregions and sections included in the geographic area in a different color than the subregions and sections that are excluded from the geographic area.

7. The method of claim 5, wherein depicting the subregions and sections further includes denoting the subregions and sections included in the geographic area in a different shading than the subregions and sections that are excluded from the geographic area.

8. A method for defining and identifying geographic areas, comprising:
providing for a geographic region wherein the geographic region is divided into states, and wherein the states are divided into postal codes;
receiving a query to identify a geographic area wherein the query includes an indication of at least one of a set of states and a set of postal codes and including in the query at least one of a plus sign and a minus sign, wherein the plus sign is included when at least one of the set of states and one of the set of postal codes is to be included in the geographic area and a minus sign is included when at least one of the set of states or one of the set of postal codes is to be excluded from the geographic region; and
outputting a response including information related to the geographic area wherein the at least one of the set of states and the set of postal codes preceded with a plus sign is included in the geographic area and the at least one of the set of states and the set of postal codes preceded with a minus sign is excluded from the geographic area.

9. The method of claim 8, wherein postal codes can be identified by at least one number included in the postal code, starting with the first number of the postal code.

10. The method of claim 8, wherein the response includes a pictorial diagram wherein the identified geographic area is viewably different than those states and postal codes that are excluded from the geographic area.

11. A method for defining and identifying a geographic area, comprising:
providing for a geographic region wherein the geographic region is divided into subregions that are mutually exclusive, and wherein the subregions are divided sections that are mutually exclusive;
receiving a query to define a geographic area wherein the query includes an indication of at least one of a set of subregions and a set of sections and including in the query at least one of a plus sign and a minus sign, wherein the plus sign is included when at least one of the set of subregions and one of the set of sections is to be included in the geographic area and a minus sign is included when at least one of the set of subregions or one of the set of sections is to be excluded from the geographic region; and
outputting a pictorial diagram representative of the query wherein the pictorial diagram includes at least part of the region including the defined geographic area wherein the geographic area is viewably different from the subregions and sections that are excluded from the geographic area.

12. The method of claim 11, wherein the subregions are states and the sections are postal codes.

13. The method of claim 12, wherein sections can be identified by at least one number included in the postal code, starting with the first number of the postal code.

14. An apparatus for defining and identifying geographic areas, comprising:
a memory having program instructions;
a display screen; and
a processor responsive to the program instructions to
provide for a geographic region wherein the geographic region is divided into subregions that are mutually exclusive, and wherein the subregions are divided into sections that are mutually exclusive;
receive a query for defining a geographic area wherein the query includes an indication of at least one of a set of subregions and a set of sections;
determine whether the reference to at least one of the set of subregions and the set of sections indicates the at least one of the set of subregions and the set of sections are to be included in the geographic area;
determine whether the reference to the at least one of the set of subregions and the set of sections indicates the at least one of the set of subregions and the set of sections are to be excluded from the geographic area; and
output a response including information relating to the geographic area wherein the geographic area is representative of the query.

15. The apparatus of claim 14, wherein the subregions are states and the sections are postal codes.

16. The apparatus of claim 15, wherein sections can be identified by at least one number included in the postal code, starting with the first number of the postal code.

17. The apparatus of claim 14, wherein the processor is further configured to:
incorporate in the query a plus sign to add at least one of a subregion contained in the set of subregions and a section contained in the set of sections to the geographic area; and
incorporate in the query a minus sign to exclude at least one of a subregion contained in the set of subregions and a section contained in the set of sections to the geographic area.

18. The apparatus of claim 14, wherein the processor is further configured to:
incorporating in the response a pictorial diagram of the geographic area; and
depict the subregions and sections that are included in the geographic region in a different manner than the subregions and sections that are excluded from geographic area.

19. The apparatus of claim 18, wherein the processor is further configured to denote the subregions and sections included in the geographic area in a different color than the subregions and sections that are excluded from the geographic area.

20. The apparatus of claim 18, wherein the processor is further configured to denote the subregions and sections included in the geographic area in a different shading than the subregions and sections that are excluded from the geographic area.

21. An apparatus for defining and identifying geographic areas, comprising:
a memory having program instructions;
a display screen; and
a processor responsive to the program instructions to
provide for a geographic region wherein the geographic region is divided into states, and wherein the states are divided into postal codes;
receive a query to identify a geographic area wherein the query includes an indication of at least one of a set of states and a set of postal codes and including in the query at least one of a plus sign and a minus sign, wherein the plus sign is included when at least one of the set of states and one of the set of postal codes is to be included in the geographic area and a minus sign is included when at least one of the set of states or one of the set of postal codes is to be excluded from the geographic region; and
output a response including information related to the geographic area wherein the at least one of the set of states and the set of postal codes preceded with a plus sign is included in the geographic area and the at least one of the set of states and the set of postal codes preceded with a minus sign is excluded from the geographic area.

22. The apparatus of claim 21, wherein postal codes can be identified by at least one number included in the postal code, starting with the first number of the postal code.

23. The apparatus of claim 22, wherein the response includes a pictorial diagram wherein the identified geographic area is viewably different than those states and postal codes that are excluded from the geographic area.

24. An apparatus for defining and identifying a geographic area, comprising:
a memory having program instructions;
a display screen; and
a processor responsive to the program instructions to
provide for a geographic region wherein the geographic region is divided into subregions that are mutually exclusive, and wherein the subregions are divided sections that are mutually exclusive;
receive a query to define a geographic area wherein the query includes an indication of at least one of a set of subregions and a set of sections and including in the query at least one of a plus sign and a minus sign, wherein the plus sign is included when at least one of the set of subregions and one of the set of sections is to be included in the geographic area and a minus sign is included when at least one of the set of subregions or one of the set of sections is to be excluded from the geographic region; and
output a pictorial diagram representative of the query wherein the pictorial diagram includes at least part of the region including the defined geographic area wherein the geographic area is viewably different from the subregions and sections that are excluded from the geographic area.

25. The apparatus of claim 24, wherein the subregions are states and the sections are postal codes.

26. The apparatus of claim 24, wherein sections can be identified by at least one number included in the postal code, starting with the first number of the postal code.

27. A computer-readable medium containing instructions for defining and identifying geographic areas, the system comprising:
providing for a geographic region wherein the geographic region is divided into subregions that are mutually exclusive, and wherein the subregions are divided into sections that are mutually exclusive;
receiving a query for defining a geographic area wherein the query includes an indication of at least one of a set of subregions and a set of sections;
determining whether the reference to at least one of the set of subregions and the set of sections indicates the at least one of the set of subregions and the set of sections are to be included in the geographic area;
determining whether the reference to the at least one of the set of subregions and the set of sections indicates the at least one of the set of subregions and the set of sections are to be excluded from the geographic area; and
outputting a response including information relating to the geographic area wherein the geographic area is representative of the query.

28. The computer-readable medium of claim 27, wherein the subregions are states and the sections are postal codes.

29. The computer-readable medium of claim 28, wherein sections can be identified by at least one number included in the postal code, starting with the first number of the postal code.

30. The computer-readable medium of claim 27, wherein receiving a query includes:
incorporating in the query a plus sign to add at least one of a subregion contained in the set of subregions and a section contained in the set of sections to the geographic area; and
incorporating in the query a minus sign to exclude at least one of a subregion contained in the set of subregions and a section contained in the set of sections to the geographic area.

31. The computer-readable medium of claim 27, wherein outputting the response further includes:
incorporating in the response a pictorial diagram of the geographic area; and
depicting the subregions and sections that are included in the geographic region in a different manner than the subregions and sections that are excluded from geographic area.

32. The computer-readable medium of claim 31, wherein depicting the subregions and sections further includes denoting the subregions and sections included in the geographic area in a different color than the subregions and sections that are excluded from the geographic area.

33. The computer-readable medium of claim 31, wherein depicting the subregions and sections further includes denoting the subregions and sections included in the geographic area in a different shading than the subregions and sections that are excluded from the geographic area.

34. A computer-readable medium containing instructions for defining and identifying geographic areas, comprising:
providing for a geographic region wherein the geographic region is divided into states, and wherein the states are divided into postal codes;
receiving a query to identify a geographic area wherein the query includes an indication of at least one of a set of states and a set of postal codes and including in the query at least one of a plus sign and a minus sign, wherein the plus sign is included when at least one of the set of states and one of the set of postal codes is to be included in the geographic area and a minus sign is included when at least one of the set of states or one of the set of postal codes is to be excluded from the geographic region; and
outputting a response including information related to the geographic area wherein the at least one of the set of states and the set of postal codes preceded with a plus sign is included in the geographic area and the at least one of the set of states and the set of postal codes preceded with a minus sign is excluded from the geographic area.

35. The computer-readable medium of claim 34, wherein postal codes can be identified by at least one number included in the postal code, starting with the first number of the postal code.

36. The computer-readable medium of claim 34, wherein the response includes a pictorial diagram wherein the identified geographic area is viewably different than those states and postal codes that are excluded from the geographic area.

37. A computer-readable medium containing instructions for defining and identifying a geographic area, comprising:
providing for a geographic region wherein the geographic region is divided into subregions that are mutually exclusive, and wherein the subregions are divided sections that are mutually exclusive;
receiving a query to define a geographic area wherein the query includes an indication of at least one of a set of subregions and a set of sections and including in the query at least one of a plus sign and a minus sign, wherein the plus sign is included when at least one of the set of subregions and one of the set of sections is to be included in the geographic area and a minus sign is included when at least one of the set of subregions or one of the set of sections is to be excluded from the geographic region; and
outputting a pictorial diagram representative of the query wherein the pictorial diagram includes at least part of the region including the defined geographic area wherein the geographic area is viewably different from the subregions and sections that are excluded from the geographic area.

38. The computer-readable medium of claim 37, wherein the subregions are states and the sections are postal codes.

39. The computer-readable medium of claim 38, wherein sections can be identified by at least one number included in the postal code, starting with the first number of the postal code.

40. A system for defining and identifying geographic areas, comprising:
means for providing for a geographic region wherein the geographic region is divided into subregions that are mutually exclusive, and wherein the subregions are divided into sections that are mutually exclusive;
means for receiving a query for defining a geographic area wherein the query includes an indication of at least one of a set of subregions and a set of sections;
means for determining whether the reference to at least one of the set of subregions and the set of sections indicates the at least one of the set of subregions and the set of sections are to be included in the geographic area;
means for determining whether the reference to the at least one of the set of subregions and the set of sections indicates the at least one of the set of subregions and the set of sections are to be excluded from the geographic area; and
means for outputting a response including information relating to the geographic area wherein the geographic area is representative of the query.

41. The system of claim 40, wherein the subregions are states and the sections are postal codes.

42. The system of claim 41, wherein sections can be identified by at least one number included in the postal code, starting with the first number of the postal code.

43. The system of claim 40, wherein means for receiving a query includes:
means for incorporating in the query a plus sign to add at least one of a subregion contained in the set of subregions and a section contained in the set of sections to the geographic area; and
means for incorporating in the query a minus sign to exclude at least one of a subregion contained in the set of subregions and a section contained in the set of sections to the geographic area.

44. The system of claim 40, wherein means for outputting the response further includes:
means for incorporating in the response a pictorial diagram of the geographic area; and
means for depicting the subregions and sections that are included in the geographic region in a different manner than the subregions and sections that are excluded from geographic area.

45. The system of claim 44, wherein means for depicting the subregions and sections further includes means for denoting the subregions and sections included in the geographic area in a different color than the subregions and sections that are excluded from the geographic area.

46. The system of claim 5, wherein means for depicting the subregions and sections further includes means for denoting the subregions and sections included in the geographic area in a different shading than the subregions and sections that are excluded from the geographic area.

47. A system for defining and identifying geographic areas, comprising:
means for providing for a geographic region wherein the geographic region is divided into states, and wherein the states are divided into postal codes;
means for receiving a query to identify a geographic area wherein the query includes a, indication of at least one of a set of states and a set of postal codes and including in the query at least one of a plus sign and a minus sign, wherein the plus sign is included when at least one of the set of states and one of the set of postal codes is to be included in the geographic area and a minus sign is included when at least one of the set of states or one of the set of postal codes is to be excluded from the geographic region; and
means for outputting a response including information related to the geographic area wherein the at least one of the set of states and the set of postal codes preceded with a plus sign is included in the geographic area and the at least one of the set of states and the set of postal codes preceded with a minus sign is excluded from the geographic area.

48. The system of claim 47, wherein postal codes can be identified by at least one number included in the postal code, starting with the first number of the postal code.

49. The system of claim 47, wherein the response includes a pictorial diagram wherein the identified geographic area is viewably different than those states and postal codes that are excluded from the geographic area.

50. A system for defining and identifying a geographic area, comprising:
means for providing for a geographic region wherein the geographic region is divided into subregions that are mutually exclusive, and wherein the subregions are divided sections that are mutually exclusive;
means for receiving a query to define a geographic area wherein the query includes an indication of at least one of a set of subregions and a set of sections and including in the query at least one of a plus sign and a minus sign, wherein the plus sign is included when at least one of the set of subregions and one of the set of sections is to be included in the geographic area and a minus sign is included when at least one of the set of subregions or one of the set of sections is to be excluded from the geographic region; and
means for outputting a pictorial diagram representative of the query wherein the pictorial diagram includes at least part of the region including the defined geographic area wherein the geographic area is viewably different from the subregions and sections that are excluded from the geographic area.

51. The system of claim 50, wherein the subregions are states and the sections are postal codes.

52. The system of claim 51, wherein sections can be identified by at least one number included in the postal code, starting with the first number of the postal code.
